(19) United States
(12) Patent Application Publication
(10) Pub. No.: US 2010/0019608 A1
(43) Pub. Date: Jan. 28, 2010

(54) THREE PHASE ROTARY GENERATOR

(76) Inventor: Chao-Hsiung Lin, Taoyuan County (TW)

Correspondence Address: Chao-Hsiung Lin, 235 Chung - Ho Box 8-24, Taipei, 235, TW

(21) Appl. No.: 12/490,303

(22) Filed: Jun. 23, 2009

(30) Foreign Application Priority Data
Jul. 27, 2008 (TW) 97211517

(51) Int. Cl. H02K 3/28; H02K 1/16

(52) U.S. Cl. 310/195; 310/216.069

(57) ABSTRACT

A generator includes a stator and a rotor. An inner side of the stator has a plurality of wire slots which are arranged in parallel. Coils are wound in the wire slots. The stator has a shape of a round ring with a central axis. Each wire slot is inclined to the central axis of the stator. Such a structure serves to increase the induction area to prevent from magnetic saturation so as to have preferred induction voltage and current. The coil is wound from a first one of the wire slots to a second one of the wire slots, where the first and second wire slots are spaced by another wire slot.

### FIELD OF THE INVENTION

The present invention related to generators, in particular to a three phase rotary generator, in that the wires of coils of the generator are wound from a first wire slot to a second wire slot, where the first and second wire slots are spaced by another wire slot.

### BACKGROUND OF THE INVENTION

A prior art generator includes a stator and a rotor. The rotor rotates in the stator so as to induce an electric power. An external force drives the rotor to rotate continuously so that the surfaces of the coils of the stator will cut through the magnetic fields with different angles so that magnetic field passing through the coils will change with time and thus the electric power will be generated.

However the prior art stator of the generator only has less area for induction of electric power due to the magnetic saturation of the coils and thus the current output and voltage output are low.

The object of the present invention is to provide a three phase rotary generator which can improve the prior art defects.

### SUMMARY OF THE INVENTION

The object of the present invention is to provide a three phase rotary generator comprising: a stator and a rotor; an inner side of the stator having a plurality of wire slots which are arranged in parallel; coils are wound in the wire slots; the stator having a shape of a round ring with a central axis; wires of the coil being wound from a first one of the wire slots to a second one of the wire slots, where the first and second wire slots are spaced by another wire slot.

Each wire slot is inclined to the central axis of the stator or each wire slot is parallel to the central axis of the stator. The wire of the coils is firstly wound in the first wire slot and then to the 5^{th} wire slot, then to a 2^{nd} wire slot, then to a 6^{th} wire slot, then to a 10^{th} wire slot, then to the 6^{th} wire slot, then to the 10^{th} wire slot; then to a 14^{th} wire slot, then to a 11 wire slot, then to a 15^{th} wire slot, then to a 19^{th} wire slot, then to the 15^{th} wire slot, then to the 19 wire slot, then to a 23^{th} wire slot, then to a 20 wire slot, then to a 24 wire slot, than to the 1^{st} wire slot and then to the 24^{th} wire slot and then to the 1^{st} wire slot to repeat the above mentioned sequence.

Thus the present invention provides a larger induction area for avoiding magnetic saturation so as to have preferred induction voltage and current. Furthermore, the present invention is useable in industry and can be connected to a hand driving or a leg driving module to achieve the object of power generation.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is a structural schematic view of the stator of the present invention.

FIG. 3 is a schematic view showing the winding way of the phase A in the stator.

FIG. 4 is a schematic view showing the winding way of the three phases of the stator according to the present invention.

FIG. 5 is a block diagram of the present invention.

FIG. 6 shows another structure of the stator of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

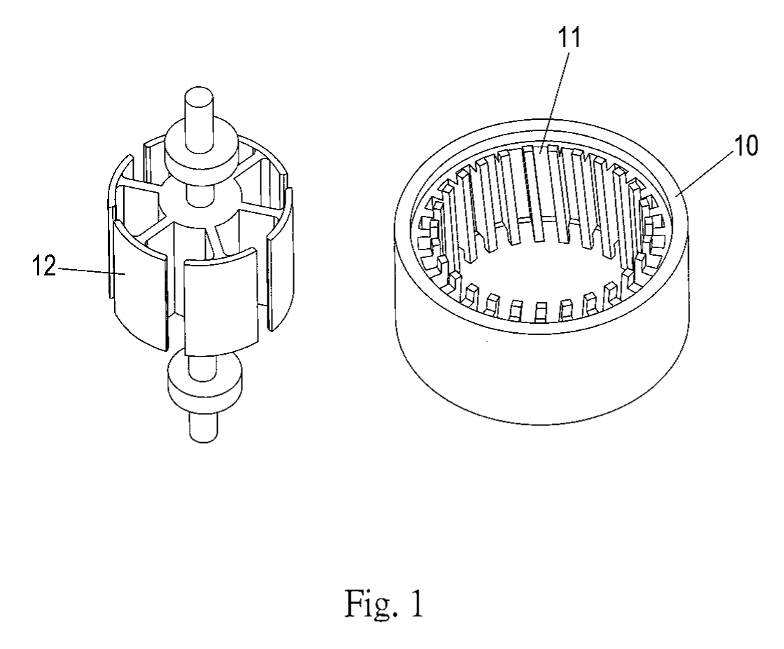

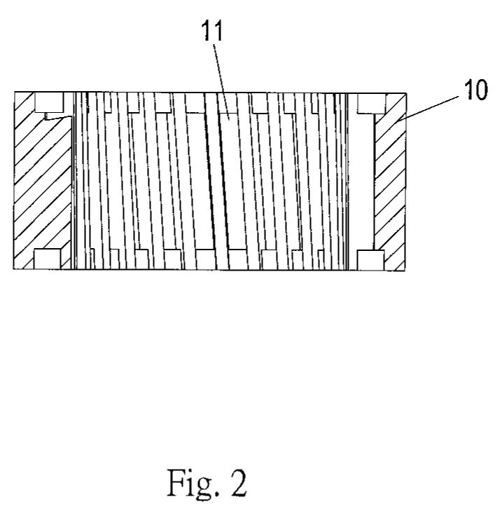

A three phase rotary generator includes a stator 10 and a rotor 12. An inner side of the stator 10 has a plurality of wire slots 11 which are arranged in parallel. Coils are wound in the wire slots 11. The stator 10 has a shape of a round ring with a virtual central axis. Each wire slot 11 is inclined to the central axis of the stator 10 as illustrated in FIGS. 1 and 2 of the present invention. Such a structure serves to increase the induction area to prevent from magnetic saturation so as to have preferred induction voltage and current. The coil is wound from a first one of the wire slots 11 to a second one of the wire slots 11, where the first and second wire slots 11 are spaced by another wire slot 11.

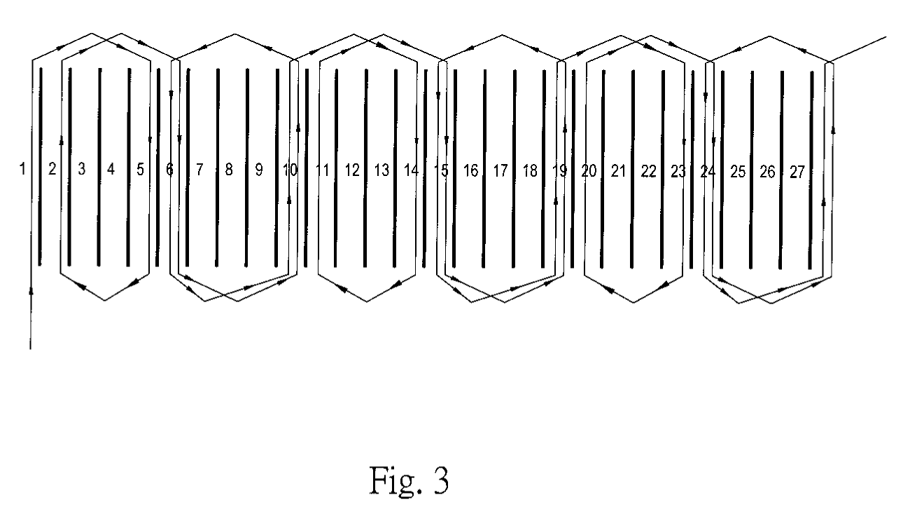

With reference to FIG. 3, the winding way of the present invention is illustrated. It is illustrated that the stator 11 includes 27 wire slots 11. The wire for the phase A of the coils is firstly wound in the first wire slot and then to the 5^{th} wire slot, then to a 2^{nd} wire slot, then to a 6^{th} wire slot, then to a 10^{th} wire slot, then to the 6^{th} wire slot, then to the 10^{th} wire slot; then to a 14^{th} wire slot, then to a 11 wire slot, then to a 15^{th} wire slot, then to a 19^{th} wire slot, then to the 15^{th} wire slot, then to the 19 wire slot, then to a 23^{th} wire slot, then to a 20 wire slot, then to a 24 wire slot, than to the 1^{st} wire slot and then to the 24^{th} wire slot and then to the 1^{st} wire slot to repeat the above mentioned sequence.

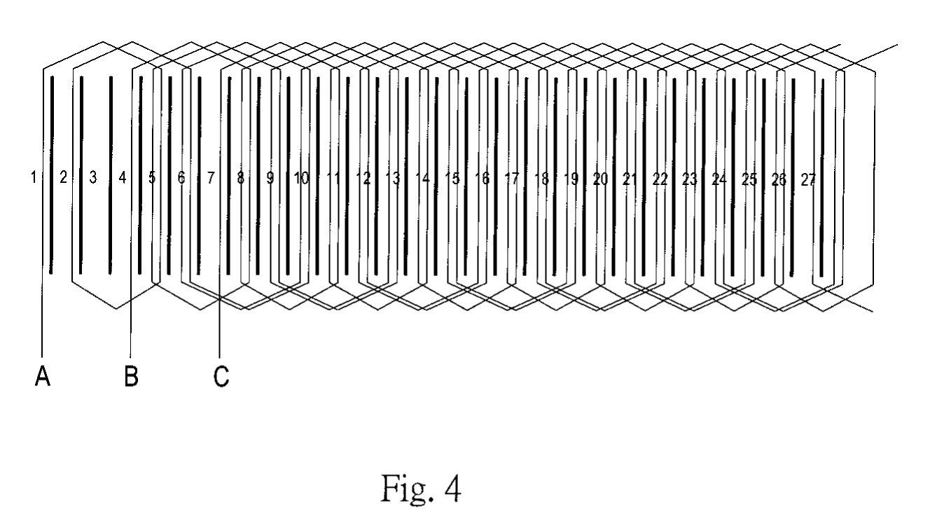

With reference to FIG. 4, the winding way for three phases of the stator 11 is illustrated. It is illustrated that three phases A, B and C are wound as described above. The phase A firstly enters into the first wire slot and then wound other wire slot with same logic as described for phase A. The phase B firstly enters into the 4^{th} wire slot and then wound other wire slot with same logic as described for phase A. The phase C firstly enters into the 7^{th} wire slot and then wound other wire slot with same logic as described for phase A.

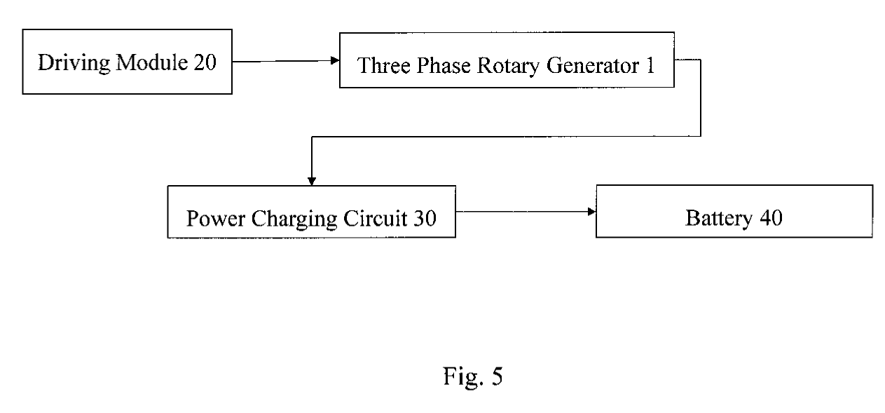

Referring to FIG. 5, a block diagram about the application of the present invention is illustrated. A three phase rotary generator 1 has an input end which is connected to a driving module 20. The driving module 20 is a hand driving or a leg driving device. The driving module 20 serves to drive the generator 1. The AC power from an output end of the generator 1 is converted to DC power for outputting so as to charge a battery 40.

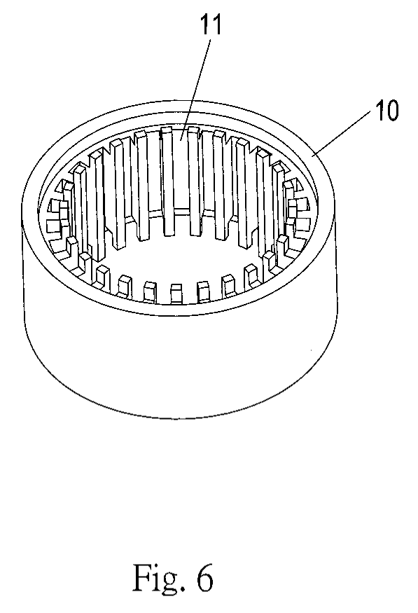

Referring to FIG. 6, a perspective view about the stator of the present invention is illustrated. It is illustrated that the wire slots 11 are arranged within the stator 11 in parallel and are parallel to the axis of the stator.

Advantages of the present invention are that the present invention provides a larger induction area for avoiding magnetic saturation so as to have preferred induction voltage and current. Furthermore, the present invention is useable in industry and can be connected to a hand driving or a leg driving module to achieve the object of power generation.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A three phase rotary generator comprising: a stator and a rotor; an inner side of the stator having a plurality of wire slots which are arranged in parallel; coils are wound in the wire slots; the stator having a shape of a round ring with a central axis; wires of the coil being wound from a first one of the wire slots to a second one of the wire slots, where the first and second wire slots are spaced by another wire slot.

2. The three phase rotary generator as claimed in claim 1, wherein the stator is a round ring with a central axis and each wire slot is inclined to the central axis of the stator.

3. The three phase rotary generator as claimed in claim 1, wherein the stator is a round ring with a central axis and each wire slot is parallel to the central axis of the stator.

4. The three phase rotary generator as claimed in claim 1, wherein the wire of the coils is firstly wound in a 1^{st} slot and then to the 5^{th} wire slot, then to a 2^{nd} wire slot, then to a 6^{th} wire slot, then to a 10^{th} wire slot, then to the 6^{th} wire slot, then to the 10^{th} wire slot; then to a 14^{th} wire slot, then to a 11 wire slot, then to a 15^{th} wire slot, then to a 19^{th} wire slot, then to the 15^{th} wire slot, then to the 19 wire slot, then to a 23^{th} wire slots then to a 20 wire slot, then to a 24 wire slot, than to the 1^{st} wire slot and then to the 24^{th} wire slot and then to the 1^{st} wire slot to repeat the above mentioned sequence.
